(19) United States
(12) Patent Application Publication
(10) Pub. No.: US 2004/0117669 A1
(43) Pub. Date: Jun. 17, 2004

(54) Method for controlling heat dissipation of a microprocessor

(76) Inventor: Peter A. Wilson, Mountain View, CA (US)

Correspondence Address: HOYT A. FLEMING III, P.O. BOX 140678, BOISE, ID, 83714, US

(21) Appl. No.: 10/317,472

(22) Filed: Dec. 12, 2002

(51) Int. Cl. G06F 1/26

(52) U.S. Cl. 713/300

(57) ABSTRACT

A method of reducing the heat dissipation of a microprocessor. The method includes measuring the temperature of a location on a microprocessor and then comparing the measured temperature with a reference temperature. Based at least in part upon the comparison, the microprocessor enters into one of at least two reduced power states. The reduced power states may include states in which portions of a cache are inactivated or flushed, entire caches are disabled, microprocessor clock speeds are reduced, microprocessor core voltages are reduced, and/or page faults are generated.

### 1. FIELD OF THE INVENTION

The present invention generally relates to methods of controlling heat dissipation of a microprocessor. More specifically, the present invention relates to methods of controlling the heat dissipation of a microprocessor by reducing the performance of the microprocessor.

### 2. BACKGROUND

Modern microprocessors continue to increase their performance. In particular, the clock speeds of such microprocessors have continued to rapidly increase. In addition, memory speeds, bus speeds and cache sizes continue to increase. As a result, the microprocessors' execution pipelines are rarely starved for data. One unfortunate side effect of efficiently operating a high-performance microprocessor is that the microprocessor dissipates a large amount of heat.

When a high-performance microprocessor is installed in a desktop computer system, such as an ATX compliant computer system, the dissipated heat can be easily removed. However, if many high-performance microprocessors are installed in a relatively small, rack-mounted server, such as a blade server, dissipating the heat from the microprocessors can be difficult.

Some microprocessors reduce the performance of the microprocessor to avoid overheating the microprocessor. For example, a microprocessor may decrease its clock speed to a very low value and remove power from certain microprocessor components to rapidly reduce the microprocessor's heat dissipation. Similarly, other microprocessors may reduce the microprocessors' core voltage to rapidly reduce the microprocessors' heat dissipation. While these microprocessors reduce performance to avoid damaging the microprocessor, they do not provide the ability to precisely control heat dissipation. As a result, the performance of the microprocessor cannot be maximized for a given thermal environment.

Thus, a method of decreasing the heat dissipation of a microprocessor is needed while maximizing the performance of the microprocessor for a given thermal environment.

### 3. SUMMARY OF INVENTION

One embodiment of the invention is a method of reducing the heat dissipation of a microprocessor. The method includes measuring the temperature of a location on or near a microprocessor and then comparing the measured temperature with a reference temperature, which may be configurable. Based at least in part upon the comparison, the microprocessor enters into one of at least two reduced power states. The reduced power states may include reduced power states in which portions of a cache are marked as unusable, entire caches are disabled, microprocessor clock speeds are reduced, microprocessor core voltages are reduced, and/or page faults are generated.

Another embodiment of the invention is a microprocessor that includes a cache that includes a plurality of caches lines and a temperature sensor. The microprocessor also includes circuitry that can receive a measured temperature value from the temperature sensor, compare the temperature value with a reference temperature, and based at least in part upon the comparison, inactivate one or more of the plurality of cache lines. In some embodiments of the invention, the reference temperature is a microprocessor target operating temperature or a microprocessor maximum operating temperature, either of which may be configurable. In addition, the power to portions of caches or even entire caches may be removed in order to reduce the heat dissipation of the microprocessor.

Still another embodiment of the invention is a microprocessor that contains circuitry that, based at least in part upon the comparison, can disable the cache or can disable an external cache.

### 4. BRIEF DESCRIPTION OF THE FIGURES

FIG. 1 presents a flow chart of one method of controlling the heat dissipation of a microprocessor.

FIG. 2 presents a block diagram of a computer system.

FIG. 3 presents a graph of the temperature of a location on a microprocessor.

FIG. 4 presents another graph of the temperature of a location on a microprocessor.

FIG. 5 presents another flow chart of a method of controlling the heat dissipation of a microprocessor.

FIG. 6 presents still another flow chart of a method of controlling the heat dissipation of a microprocessor.

FIG. 7 presents yet another flow chart of a method of controlling the heat dissipation of a microprocessor.

### 5. DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principle and features disclosed herein.

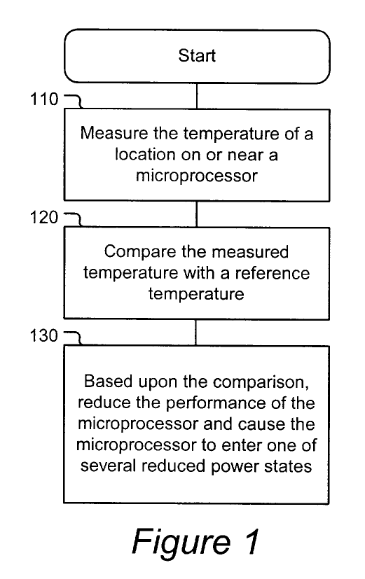

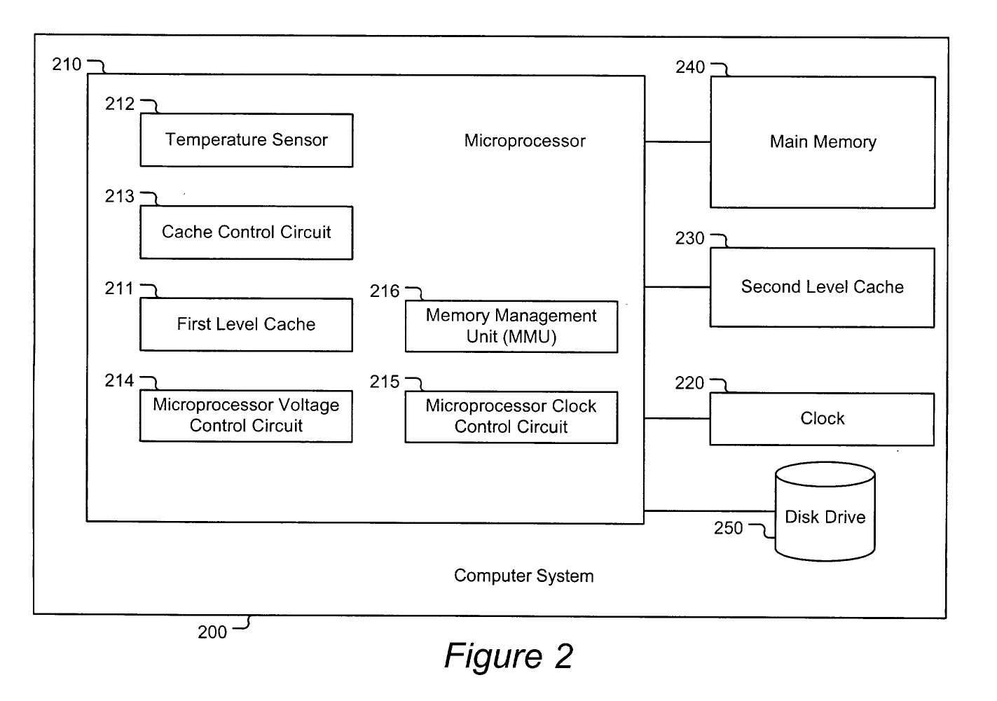

One embodiment of the invention is a method, performed by a computer system, of reducing the heat dissipation of a microprocessor. A flow chart of the method is shown in FIG. 1. The method shown in FIG. 1 may be utilized to reduce the heat dissipation of the microprocessor 210 shown in FIG. 2.

FIG. 2 presents a simplified block diagram of a computer system 200 that includes a microprocessor 210. The microprocessor includes a first level (L1) cache 211, a temperature sensor 212, a cache control circuit 213, a microprocessor voltage control circuit 214, a microprocessor clock control circuit 215, and a memory management unit (MMU) 216. The microprocessor 210 may also be coupled to an external second level (L2) cache 230 or could include an internal L2 cache (not shown). The microprocessor 210 may also be coupled to other, more remote caches (not shown) such as L3, L4, L5 or subsequent caches. The microprocessor 210 is also coupled to an external clock 220. The microprocessor 210 is also coupled to main memory 240 which may include a number of dynamic random access memory (DRAM) devices. The microprocessor 210 may also be coupled to one or more storage units such as disk drives 250. For example, the microprocessor 210 may be coupled to a plurality of network-attached disks. Those skilled in the art will appreciate that the block diagram of FIG. 2 is simplified to illustrate only those functional elements of interest in describing the present invention. Other functional elements, such as registers, arithmetic logic units, etc. are not shown.

5.1 Measuring the Temperature

Referring to block 110 of FIG. 1, one step in the method is measuring the temperature of a location on or near the microprocessor. The temperature of a location on a microprocessor can be measured in many ways. For example, as shown in FIG. 2, a temperature sensor 212 can be utilized. Such temperature sensors are known by those of skill in the microprocessor arts.

5.2 Comparing the Measured Temperature with a Reference Temperature

Referring to block 120 of FIG. 1, in some embodiments of the invention, the measured temperature is compared with a reference temperature such as a target operating temperature for a microprocessor.

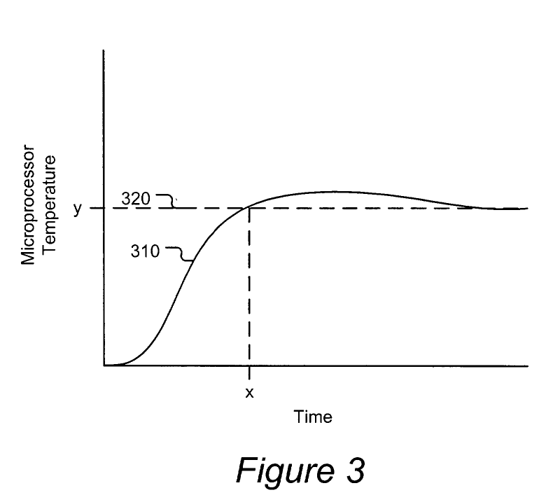

FIG. 3 presents a plot of the temperature measured by a microprocessor temperature sensor over a period of time. The measured temperature is shown as curve 310. FIG. 3 also presents a reference temperature “y” shown as line 320. This reference temperature “y” is a target operating temperature for the microprocessor. At time “x,” the measured temperature, shown as curve 310, is equal to the reference temperature “y,” shown as line 320.

5.3 Reducing the Performance of the Microprocessor

As shown in block 130 of FIG. 1, in some embodiments of the invention, the performance of the microprocessor is reduced based upon the result of a comparison of the measured temperature and a reference temperature. For example, if the measured temperature is greater than the reference temperature, then the performance of the microprocessor can be reduced. As a result of the power reduction, the microprocessor would enter into one of several reduced power states.

The reduction of the performance of the microprocessor can be accomplished in many ways, several of which will be discussed in Section 5.5. By reducing the performance of the microprocessor, the heat dissipated by the microprocessor will be reduced. Thus, the measured temperature will stabilize.

Referring again to FIG. 3, slightly after time “x,” the measured temperature, shown as curve 310, exceeds the reference temperature “y,” shown as line 320. Thus, slightly after time “x,” the performance of the microprocessor could be reduced. The microprocessor would then enter into one of several reduced power states and would dissipate less heat. As a result, the measured temperature would stabilize. Such a temperature stabilization can be seen in FIG. 3 in which the measured temperature eventually stabilizes at the reference temperature “y.”

5.4 Controlling the Performance of the Microprocessor

In some embodiments of the invention, the reference temperature is a maximum allowable microprocessor temperature as opposed to a target microprocessor temperature. In such embodiments of the invention, the microprocessor performance could be controlled so that the measured temperature would never exceed the reference temperature. For example, the rate of change of the measured temperature as well as the measured temperature could be utilized to determine whether to reduce the performance of a microprocessor. In addition, such values could be utilized to determine how much to reduce the performance of the microprocessor.

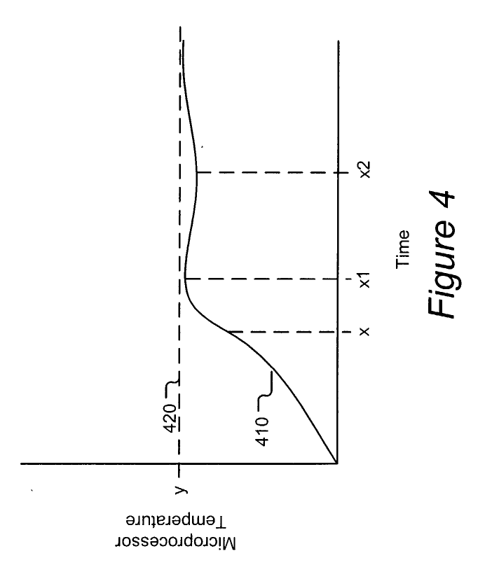

FIG. 4 presents a plot of the measured temperature of a location on a microprocessor over a period of time. The measured temperature is shown as curve 410. FIG. 4 also presents a reference temperature “y” shown as line 420. This reference temperature “y” is a maximum allowable microprocessor temperature. At time “x,” the measured temperature, curve 410, approaches the reference temperature “y,” shown as line 420. In one embodiment of the invention, at time “x1,” the computer system would disable a portion of a cache.

As is known in the microprocessor arts, there are various mapping techniques to allocate memory locations within a cache, such as direct-mapping, fully-associative mapping, and N-way set associate mapping. In such mapping techniques, the cache is typically broken down into a number of cache lines, which can be individually inactivated.

Referring again to FIG. 2, the cache control circuit 213 of microprocessor 210 could inactivate, i.e., mark as unusable, “n” cache lines of the first level cache 211 at time “x1” to reduce the performance of microprocessor 210. The inactivation of the “n” cache lines could force the microprocessor 210 to fetch data from slower cache(s) that are further from the microprocessor core and would introduce memory wait states and reduce instruction and/or data throughput. The reduction in throughput would reduce the heat dissipation of the microprocessor 210. By inactivating cache lines in a second level cache 230 and subsequent caches (not shown) would result in longer and longer delays to fetch data and would further reduce the heat dissipation of the microprocessor. The number “n” could be based upon the difference between the reference temperature and the measured temperature and/or the rate of change of the measured temperature. At time “x2,” the measured temperature, curve 410, is no longer approaching the maximum allowable temperature “y.” To the contrary, the measured temperature has stabilized well below the reference temperature. Thus, the cache control circuit 213 could enable a number of cache lines, such as “n”/2, “n”/3 or “n”/4 cache lines, of the first level cache 211 so that the measured temperature would stabilize closer to the reference temperature. In some embodiments of the invention, the number of cache lines that are re-enabled may depend on an algorithm based on modeling of the thermal inertia of the microprocessor or perhaps the entire computer system.

5.5 Other Methods of Reducing the Performance of a Microprocessor

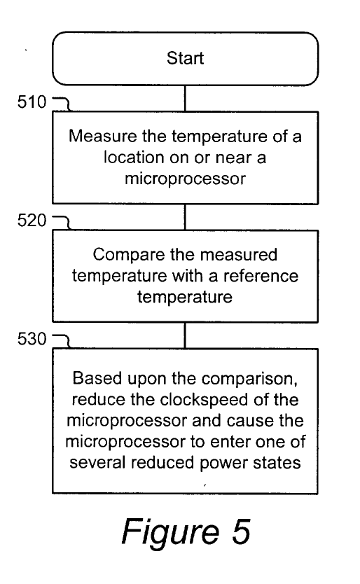

As discussed in section 5.1, there are many ways to reduce the performance of a microprocessor. FIG. 5 shows a method of reducing the performance of a microprocessor by slowing the microprocessor's clock speed. In some embodiments of the invention, the microprocessor's clock speed could be lowered to one of a number of different frequencies to control the microprocessor's heat dissipation. For example, if clock 220 in FIG. 2 was generating a clock of “s” MHz, the microprocessor clock control circuit 215 could command the microprocessor clock 220 to generate a lower clock speed of “s-z” MHz to reduce the heat dissipation of the microprocessor. The value of “z” could be determined based on the difference between the measured temperature and the reference temperature and/or rate of change of the measured temperature. The resulting lower frequency of the clock 220 would cause the microprocessor to dissipate less heat. Thus, by controlling the clock frequency, the heat dissipation of a microprocessor can be precisely controlled.

Another way to reduce the performance of a microprocessor is to generate page faults. Paging is a technique developed to provide the mapping of a larger address space to a smaller physical memory. Paging occurs when various pages of data move between physical memory (RAM) and a secondary storage device, such as a disk drive. The term “virtual memory” is often used to refer both to the process by which data is swapped between RAM and the secondary storage device, as well as to the combination of RAM and the paging file. A page fault occurs when a program has accessed a virtual memory segment that is not currently in RAM. When a page fault occurs, data is moved from the secondary storage to RAM. This movement can take a significant amount of time. As a result, the microprocessor execution pipelines can be starved for data. A byproduct of data starvation is that the heat dissipation of the microprocessor will be reduced. Thus, by generating a variable number of page faults per unit of time, the heat dissipation of a microprocessor can be precisely controlled.

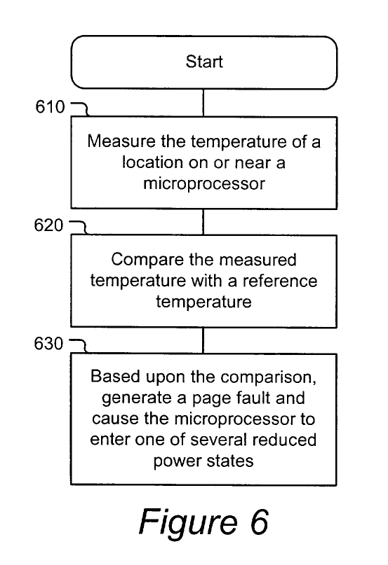

FIG. 6 provides a flowchart of a method of controlling the heat dissipation of a microprocessor by generating page faults. For example, if the measured temperature is greater than the reference temperature, the microprocessor 210 in FIG. 2 could generate “m” page faults per second to reduce the heat dissipation of the microprocessor. The number “m” could be based upon the difference between the reference temperature and the measured temperature and/or the rate of change of the measured temperature.

As time passes, circuitry within the microprocessor, the Boot ROM, and/or the operating system, could generate “m”/2 page faults per second. If the heat dissipation of the microprocessor is still too high, an additional “m”/4 page faults per second could be generated, thereby reducing the heat dissipation of the microprocessor still further. Similarly, if the reduction in the heat dissipation is too great, then the number of page faults generated could be reduced by “m”/4 page faults per second.

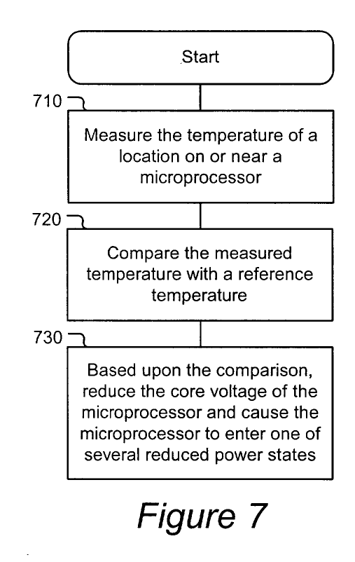

FIG. 7 presents a flowchart of a method of controlling the heat dissipation of a microprocessor that includes reducing the core voltage of the microprocessor. By reducing the core voltage of the microprocessor to one of a number of voltages, the heat dissipation of the microprocessor could be precisely controlled.

### 5.6 CONCLUSION

The foregoing descriptions of the embodiments of the present invention have been presented for purposes of illustration and description only. They are not intended to be exhaustive or to limit the present invention to the forms disclosed. Accordingly, many modifications and variations will be apparent to practitioners skilled in the art. For example, many of the methods discussed above for controlling the heat dissipation of a microprocessor may be combined. Thus, one method to control the heat dissipation of a microprocessor could control the number of inactivated cache lines in a first level cache, the number of inactivated cache lines in a second level cache, the microprocessor clock speed and the microprocessor core voltage. In addition, such a method could flush individual (or all) cache lines of first, second, and/or subsequent level caches. Further, such a method could even disable such caches for limited periods of time. For example, such a method could disable a first, second, and/or subsequent level cache for limited periods of time by removing power from such caches. Any of the foregoing methods may also remove power from portions of a microprocessor to further reduce the heat dissipation of the microprocessor. Such methods could be performed under control of circuitry within a microprocessor, under control of the Boot ROM, under control of an operating system, and/or under control of an application program running on top of the operating system. By precisely controlling the heat dissipation of the microprocessor, the performance of the microprocessor can be maximized for a given thermal environment.

Still other embodiments of the invention could set various parameters within the microprocessor, Boot ROM, and/or operating system so that the heat dissipation of the microprocessor would be controlled without reference to any measured temperature values. These “open loop” methods could reduce the performance of the microprocessor by any of the above-discussed methods. While such “open loop” methods would not maximize the performance of a microprocessor under all thermal environments, they would be more simple to implement and would not require close monitoring of the microprocessor temperature.

Other embodiments of the invention include a computer system and/or microprocessor that can perform portions of the above methods. Still other embodiments of the invention include a program storage device containing instructions that when read by a computer system perform portions of the above methods.

The above disclosure is not intended to limit the present invention. The scope of the present invention is defined by the appended claims.

It is claimed:

1. A method of reducing the heat dissipation of a microprocessor, the method comprising:
a) measuring the temperature of a microprocessor;
b) comparing the measured temperature with a reference temperature; and
c) based at least in part upon the comparison, reducing the performance of the microprocessor;
wherein the microprocessor enters into one of at least two reduced power states.

2. The method of claim 1, wherein the reduction of the performance of the microprocessor includes flushing at least a portion of a cache.

3. The method of claim 1, wherein the reduction of the performance of the microprocessor includes disabling at least a portion of a cache.

4. The method of claim 1, wherein the reduction of the performance of the microprocessor includes disabling at least a portion of a plurality of caches.

5. The method of claim 1, wherein the reduction of the performance of the microprocessor includes repeatedly flushing at least a portion of a cache until the measured temperature is less than the reference temperature.

6. The method of claim 1, wherein the reduction of the performance of the microprocessor includes disabling at least a portion of a cache until the measured temperature is less than the reference temperature.

7. The method of claim 1, wherein the reduction of the performance of the microprocessor includes disabling at least a portion of a plurality of caches until the measured temperature is less than the reference temperature.

8. The method of claim 2, wherein flushing at least a portion of the cache includes flushing at least a portion of a first level cache included within the microprocessor.

9. The method of claim 2, wherein flushing at least a portion of the cache includes flushing at least a portion of a second level cache that is external to the microprocessor.

10. The method of claim 2, wherein flushing at least a portion of the cache includes flushing at least a portion of a first level cache included within the microprocessor and flushing at least a portion of a second level cache that is external to the microprocessor.

11. The method of claim 1 wherein the reduction of the performance of the microprocessor includes disabling a cache.

12. The method of claim 1, wherein the reduction of the performance of the microprocessor includes disabling a cache until the measured temperature is less than the reference temperature.

13. The method of claim 11, wherein disabling the cache includes disabling a first level cache included within the microprocessor.

14. The method of claim 11, wherein disabling the cache includes disabling a second level cache that is external to the microprocessor.

15. The method of claim 11, wherein disabling the cache includes disabling a first level cache included within the microprocessor and disabling a second level cache that is external to the microprocessor.

16. The method of claim 1 wherein the reduction of the performance of the microprocessor includes invalidating at least a portion of a cache.

17. The method of claim 1, wherein the reduction of the performance of the microprocessor includes invalidating a first portion of a cache and a second portion of a cache but not a third portion of a cache.

18. The method of claim 1, wherein the reduction of the performance of the microprocessor includes invalidating a portion of a cache until the measured temperature is less than the reference temperature.

19. The method of claim 1, wherein the reduction of the performance of the microprocessor includes invalidating a first portion of a cache and a second portion of a cache but not a third portion of a cache until the measured temperature is less than the reference temperature.

20. The method of claim 16, wherein invalidating the portion of the cache includes invalidating a cache line within a first level cache.

21. The method of claim 16, wherein invalidating the portion of the cache includes invalidating a cache line within a second level cache.

22. The method of claim 16, wherein invalidating a portion of the cache includes invalidating a first cache line included in a first level cache and invalidating a second cache line included in a second level cache.

23. The method of claim 1, wherein the reduction of the performance of the microprocessor includes generating a page fault.

24. The method of claim 1, wherein the reduction of the performance of the microprocessor includes generating a plurality of page faults.

25. The method of claim 1, wherein the reduction of the performance of the microprocessor includes periodically generating page faults until the measured temperature is less than the reference temperature.

26. The method of claim 1, wherein the reduction of the performance of the microprocessor includes reducing the clock speed of the microprocessor.

27. The method of claim 1, wherein the reduction of the performance of the microprocessor includes reducing the clock speed of the microprocessor until the measured temperature is less than the reference temperature.

28. The method of claim 1, wherein the reduction of the performance of the microprocessor includes reducing the core voltage of the microprocessor.

29. The method of claim 1, wherein the reduction of the performance of the microprocessor includes reducing the core voltage of the microprocessor until the measured temperature is less than the reference temperature.

30. The method of claim 1, wherein the reduction of the performance of the microprocessor includes removing power from a portion of the microprocessor.

31. The method of claim 1, wherein the reduction of the performance of the microprocessor includes removing power from a portion of the microprocessor until the measured temperature is less than the reference temperature.

32. A microprocessor comprising:
a) a cache that includes a plurality of caches lines;
b) a temperature sensor; and
c) circuitry within the microprocessor that is operable to receive a measured temperature value from the temperature sensor, compare the value with a reference temperature, and based at least in part upon the comparison, inactivate one of the plurality of cache lines.

33. A microprocessor comprising:
a) a cache;
b) a temperature sensor; and
c) circuitry within the microprocessor that is operable to receive a measured temperature value from the temperature sensor, compare the value with a reference temperature, and based at least in part upon the comparison, disable the cache.
